(19) United States
(12) Patent Application Publication
(10) Pub. No.: US 2014/0023346 A1
(43) Pub. Date: Jan. 23, 2014

(54) Shuffling Video for Privacy Protection

(71) Applicant: David Bar-On, Givat Ella (IL)

(72) Inventor: David Bar-On, Givat Ella (IL)

(21) Appl. No.: 13/550,749

(22) Filed: Jul. 17, 2012

(51) Int. Cl. H04N 9/80

(52) U.S. Cl. 386/252; 386/E05.003

(57) ABSTRACT

In some embodiments, privacy protection may be achieved for video streams that are recorded on a substantially ongoing basis, for example for gesture recognition purposes. The address of recorded groups of pixels making up the video stream may be shuffled in memory. That is, instead of changing the data, successive pixels are not written successively into the memory but instead the data may be shuffled so that whatever is in memory is unrecognizable.

### BACKGROUND

This relates generally to capturing video using cameras associated with processor-based systems.

Many people use cameras associated with processor-based systems to transmit or record video on a substantially continuous basis. For example web cameras may record a scene on an ongoing basis and publish the video over the Internet.

Other times, video may be captured on an ongoing basis but the user never intends the video to become public. One good example of this is video that is constantly recorded in order to enable gesture recognition. If the user has to turn the camera on and off all the time then it is not very effective to use gesture recognition. Therefore the camera may be recording at all times and only indicates a computer input when a gesture is recognized.

However, cameras that are running on an ongoing basis create privacy concerns. Unauthorized users or malicious software may trap the ongoing video stream and send it to an unauthorized source user.

### BRIEF DESCRIPTION OF THE DRAWINGS

Some embodiments are described with respect to the following figures:

FIG. 1 is a schematic depiction for one embodiment to the present invention;

FIG. 2 is a flow chart to enter shuffling mode according to one embodiment to the present invention;

FIG. 2A is a flow chart of the shuffle algorithm activity per frame according to one embodiment to the present invention;

FIG. 3 is a flow chart for an unshuffle algorithm according to one embodiment to the present invention;

FIG. 4 is a flow chart for an exit shuffle mode algorithm according to one embodiment to the present invention;

FIG. 5 is circuit depiction for a two chip embodiment;

FIG. 6 is a system depiction for one embodiment; and

FIG. 7 is a front elevational view of one physical implementation of the embodiment shown in FIG. 6.

### DETAILED DESCRIPTION

in some embodiments, privacy protection may be achieved for video streams that are recorded on a substantially ongoing basis, for example for gesture recognition purposes. The address of recorded groups of pixels making up the video stream may be shuffled in memory. That is, instead of changing the data, successive pixels are not written successively into the memory but instead the data may be shuffled so that whatever is in memory is unrecognizable.

For example, an encrypted picture may split a frame into small sections such as cache line sized sections. The cache line sized sections in one embodiment may be 256 bytes each. Instead of storing the picture coming out of the camera into a memory array in an ordered way, wherein the first pixel goes to the first address and the second pixel goes to the second address, the picture may be split into cache line sized sections and then the addresses of those cache line sized sections may be randomized so that if an attempt is made to read out of the memory without restructuring the sections, the picture would be shuffled in a way that makes it unrecognizable.

On the other hand, certified gesture recognition software may have access to a shuffling algorithm and a necessary key. For memory accesses, the gesture recognition software uses the appropriate address translation formula to correctly access the picture segment as part of the algorithm. The section is decrypted for a short time, however the whole picture is never stored in the original unsecured order in some embodiments.

When hardware enters the shuffling mode (the shuffling algorithm is not bypassed) a hardware-controlled indicator such as a light emitting diode may inform the user that shuffling is active. The indicator may be turned off automatically when shuffling is disabled. Access to the enable or disable bits and the shuffling key can be disabled with another, longer password.

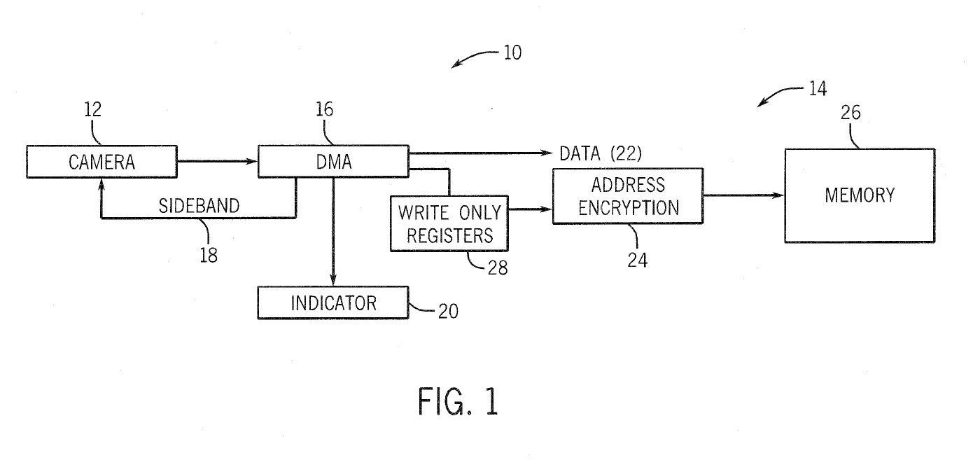

Thus referring to FIG. 1, a computer system 10, including processor based platform 14, for gesture recognition in one embodiment includes a moving picture recording camera 12 coupled to a direct memory access (DMA) engine 16. The engine 16 may be coupled to an indicator 20 such as a light indicator that indicates when picture section shuffling is active. The DMA engine 16 may also be coupled by a sideband channel 18 back to the camera 12.

The DMA engine 16 outputs data 22 and address encryption information 24. Address encryption information is used to store the picture data 22 in the memory 26. The DMA 16 may also include write only registers 28 whose purpose will be explained hereinafter.

A video sector coming from the camera 12 to the memory 26 via the DMA 16 has its address converted using an encrypting formula in the address encryption 24. One simple example of an encrypting formula is to exclusive OR (XOR) with the key most significant bits (MSBs) and rotate or shuffle some bits with key least significant bits(LSBs). However any other encrypting method can also be used. In some embodiments the conversion may be simple enough for efficient software reversal, for example using AVX special instructions in an Intel brand architecture.

According to one embodiment, the algorithm may be as follows:

Suppose the key is 1001_0010_0111_0101b i.e.
MSB = 1001_0010b LSB = 101b (0x5)
Note in this example the number is 8 bits, only 3 LSB bits
are needed for the shift
And the cache line addresses are 0x20; 0x21; 0x22; 0x23

| | | | | |
|---|---|---|---|---|
| address | a | b | c | d |
| initial | 0x20 | 0x21 | 0x22 | 0x23 |
| addresses: | | | | |
| Key MSB | 1001_0010 | 1001_0010 | 1001_0010 | 1001_0010 |
| binary input | 0010_0000 | 0010_0001 | 0010_0010 | 0010_0011 |
| address | | | | |
| After XOR | 1011_0010 | 1011_0011 | 1011_0000 | 1011_0001 |
| After rotation | 0101_0110 | 0111_0110 | 0001_0110 | 0011_0110 |
| (5 bits) | | | | |
| The new | 0x56 | 0x76 | 0x16 | 0x36 |
| addresses: | | | | |

Note:
the new addresses are spread over the picture.

The data is then stored in the memory 26 at the calculated shuffled addresses. In one embodiment cache line sized sectors may be used for efficiency but the sector size may be even smaller for better security. Generally the smaller the sector size, the more shuffled and unrecognizable would be the picture accessible from the memory without the appropriate authorizations.

To prevent creaking, by inserting test pictures into the camera pipe and detecting how a known pattern is transformed, the camera test pattern option may be disabled when the device is in encryption mode. One way to do this is by blocking the communication to the camera's image sensor via the sideband channel 18.

Certified gesture recognition software, attempting to access the picture with the original address, uses the same encrypting method and the same key to generate the encrypted addresses in order to access the memory and to unshuffle the stored picture. As the key code is in a central processing unit cache and does not require additional memory accesses for computation, the overhead on the central processing unit over the existing fetch from external memory is negligible in some embodiments.

The flow to enter the encryption code may be as follows. Secure software initiates the coding mechanism by writing two keys to the write only registers 28. One key is for the shuffle algorithm for the address translation formula and one key is for exiting from this mode.

Only when the exit key is not zero (or one in another embodiment) can the shuffle key be altered in one embodiment. Once the shuffle algorithm key is not zero, the hardware turns on the encrypting indicator 20. This indicator output cannot be enabled directly by software in some embodiments to prevent imitation by unapproved applications.

The camera DMA 16 writes the frames to the encrypted locations, resulting in shuffled and unreadable pictures being stored in memory. Unapproved applications or spy software without the key can only read the shuffled picture memory dump since they have no access to the key and cannot decrypt and read the picture in the correct or unshuffled order.

Approved applications use the translation formula to read back the picture in the ordered and meaningful manner.

Once the user wishes to exit the shuffling mode and use the raw video, the user writes the correct key to the exit register. This turns of the security indicator 20, stops the encrypting and the DMA activity resumes to the normal sequential addressing mode.

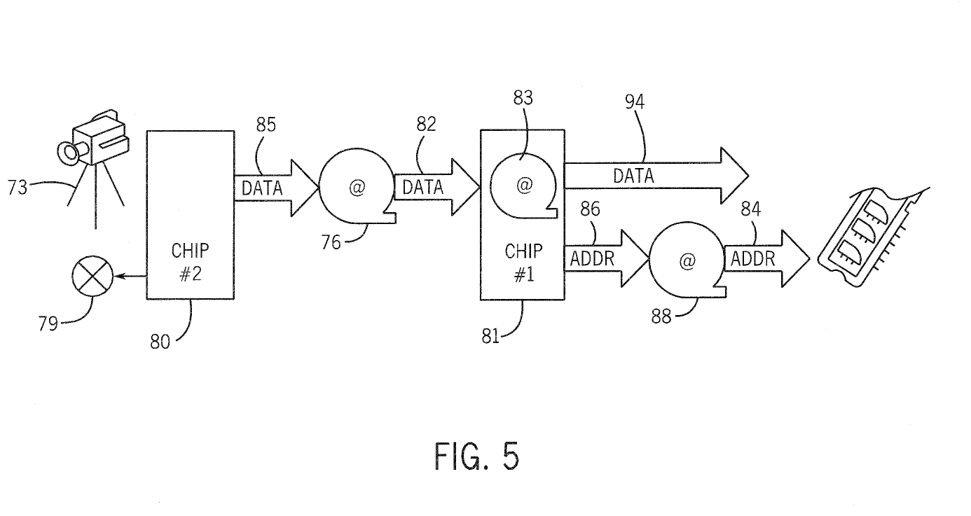

In some embodiments, a dual chip mode may be envisioned where the DMA is included in first device 81 such as a front end multiplexer and the indicator 79 is driven by a second device 80, such as the chipset as shown in FIG. 5. A mechanism may ensure that the indicator 79 is not turned on when the encrypting mechanism is off. In this case the first device enters encrypting mode, turning on the indicator 79 and encrypting the data 85 sent to the device 81. The device 81 unencrypts the data and encrypts the addresses 86 to form decrypted addresses 84. Disabling the second device from encrypting turns off the data unencrypting making the data unreadable. This mechanism assures that only if both address encrypting and data encrypting are enabled is the indicator turned on.

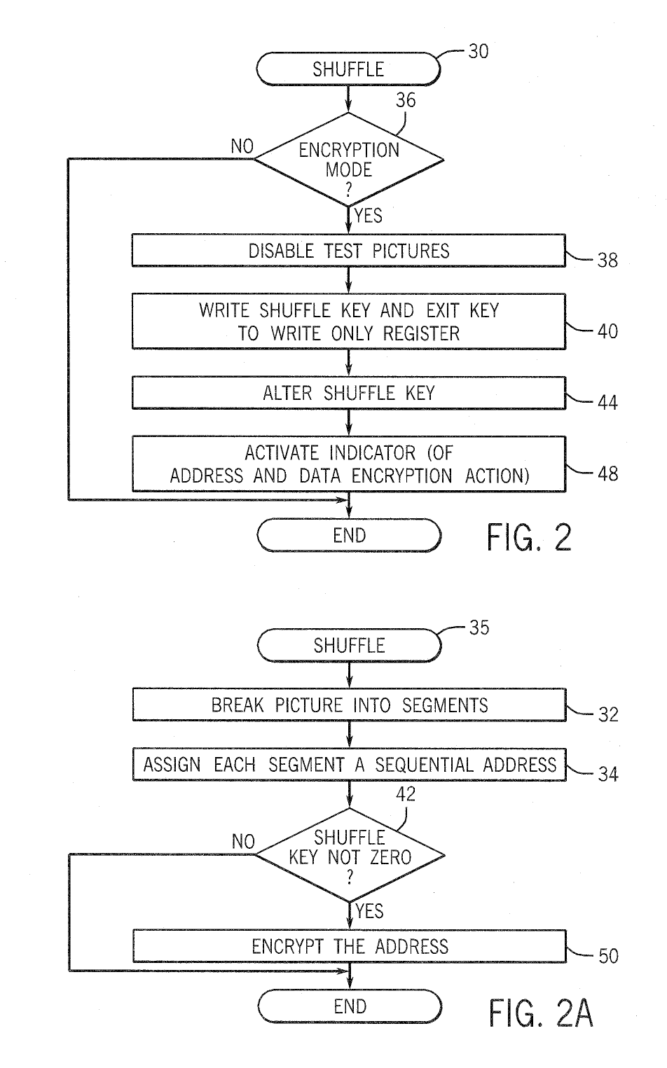

Referring to FIGS. 2, 2A, 3 and 4, the sequences 30, 35, 54, and 60 are partly implemented in software, and partly in firmware and/or hardware. In software and firmware embodiments the sequences may be implemented by computer-executed instructions stored in one or more non-transitory, computer-readable media such as magnetic, optical or semiconductor media.

Referring first to FIG. 2 a shuffle mode algorithm 30 activates a mode in which data and addresses are encrypted. The algorithm 30 begins by checking if the encryption mode is selected (shuffle key not zero) as determined in diamond 36. If so, test pictures are disabled as indicated in block 38. The shuffle key and exit keys are written to the write only register 28, as indicated in block 40. In block 44 the shuffle can be allowed. The indicator 20 is activated (block 48) to indicate active address and data encryption.

FIG. 2A is a sequence 35 to implement shuffling. The picture is broken into appropriately sized segments at block 32. Each segment is assigned a sequential address at block 34. If the shuffle key is not zero (diamond 42), because shuffling was activated (FIG. 2), then addresses are encrypted at block 50.

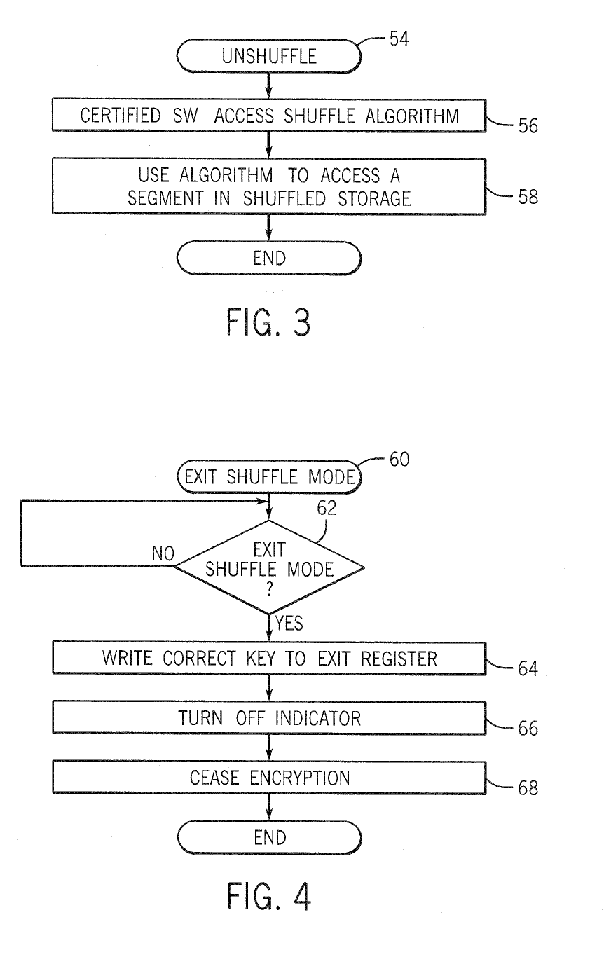

Moving next to FIG. 3, an unshuffle algorithm 54 may be effective to unshuffle the shuffled video segments. Certified software may access the shuffle algorithm 35 as indicated in block 56. Then the algorithm 35 is used to access a segment in the memory 26 until the entire picture is recreated as indicated in block 58.

Turning now to FIG. 4, a shuffle mode exit algorithm 60 begins by checking at diamond 62 to determine whether a command has been received to exit the shuffle mode. If so, the correct key is written to the exit register as indicated in block 64. Then the indicator 20 is turned off as indicated in block 66. A sideband 18 communication can be used to enable test patterns if needed by the application. Finally, picture encryption or shuffling has ceased as indicated in block 68.

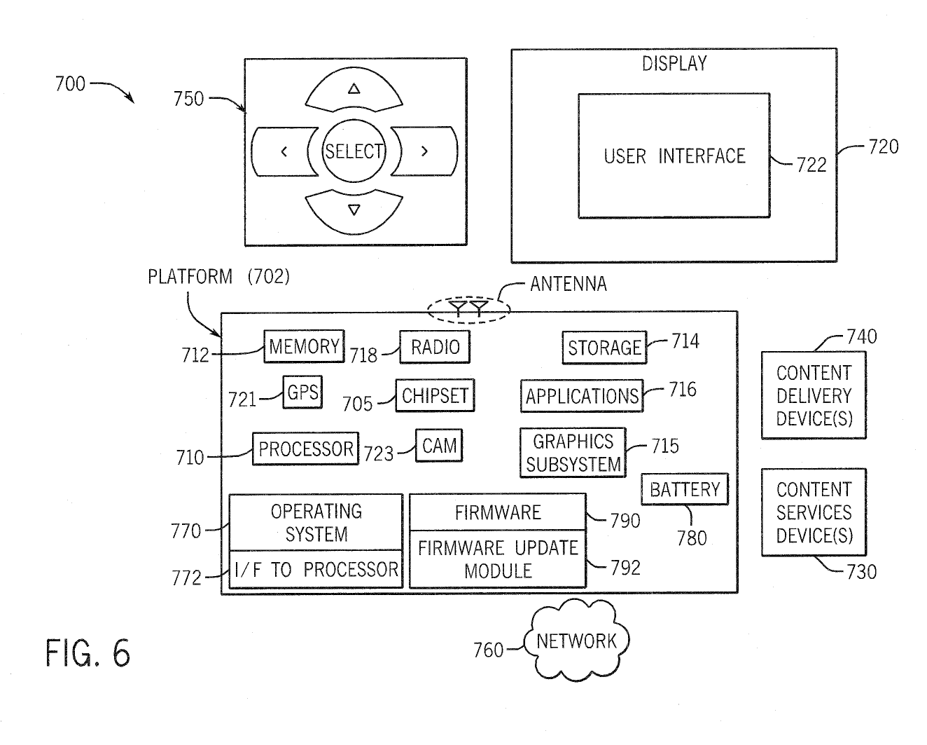

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequences shown in FIGS. 2, 2A, 3, 4 and 5 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone. Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

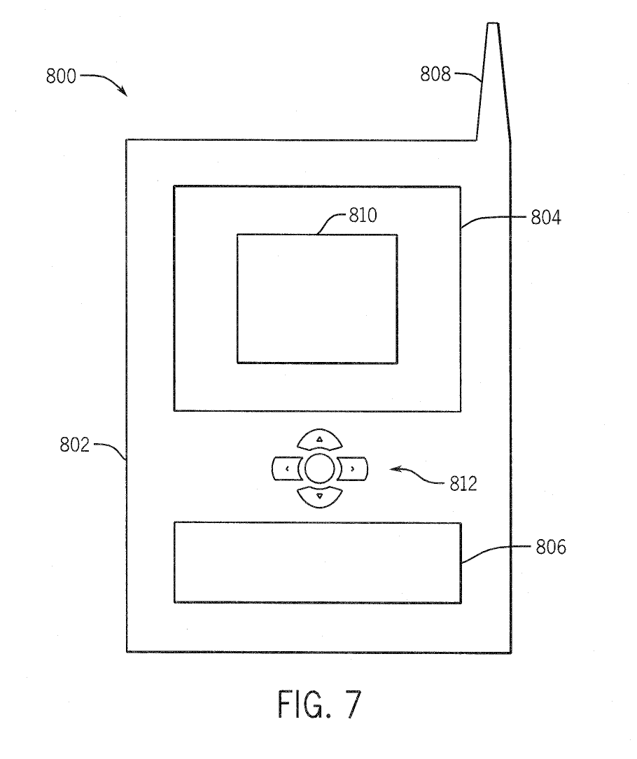

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
receiving a video stream, including pictures, from a camera;
identifying cache line sized regions of said pictures with addresses;
shuffling said addresses; and
storing said regions in a memory with addresses shuffled.

2. The method of claim 1 including indicating to a user when addresses are being shuffled.

3. The method of claim 1 including automatically disabling test pictures when shuffling is active.

4. The method of claim 1 including writing a key to exit shuffle mode to a write only register.

5. The method of claim 1 including writing a key for shuffling to a write only register.

6. The method of claim 5 including requiring the key to discontinue shuffling.

7. The method of claim 6 including automatically turning off an indicator when exiting shuffling.

8. (canceled)

9. The method of claim 1 including using a hardware controlled indicator to indicate when shuffling is active.

10. The method of claim 1 including using said video stream for gesture analysis.

11. One or more non-transitory computer readable media storing instructions to enable a processor to perform the steps of:
receiving a video stream, including pictures, from a camera;
identifying cache line sized regions of said pictures with addresses;
shuffling said addresses; and
storing said regions in a memory with addresses shuffled.

12. The media of claim 11 further storing instructions to indicate to a user when addresses are being shuffled.

13. The media of claim 11 further storing instructions to automatically disable test pictures when shuffling is active.

14. The media of claim 11 further storing instructions to write a key to exit shuffle mode to a write only register.

15. The media of claim 11 further storing instructions to write a key for shuffling to a write only register.

16. The media of claim 15 further storing instructions to require the key to discontinue shuffling.

17. The media of claim 16 further storing instructions to automatically turn off an indicator when exiting shuffling.

18. (canceled)

19. The media of claim 11 further storing instructions to use a hardware controlled indicator to indicate when shuffling is active.

20. The media of claim 11 further storing instructions to use said video stream for gesture analysis.

21. An apparatus comprising:
a memory; and
memory access engine to receive a video stream, including a picture from a camera, identify cache line sized regions of said picture with addresses, shuffle said addresses and store said region in said memory with addresses shuffled.

22. The apparatus of claim 21 including an operating system.

23. The apparatus of claim 21 including a battery.

24. The apparatus of claim 21 including firmware and a module to update said firmware.

25. The apparatus of claim 21 said apparatus including an indicator to indicate to the user when addresses are being shuffled.

26. The apparatus of claim 25 wherein said indicator is hardware controlled.

27. The apparatus of claim 21 including a write only register to store a key for shuffling said addresses.
